(19) United States
(12) Patent Application Publication
(10) Pub. No.: US 2025/0265282 A1
(43) Pub. Date: Aug. 21, 2025

(54) METHOD AND SYSTEM FOR GENERATING TRAINING DATA FOR FINE-TUNING OF MACHINE LEARNING MODEL

(71) Applicant: HCL Technologies Limited, NEW DELHI (IN)

(72) Inventors: Harikrishna C. Warrier, Bengaluru (IN); Yogesh Gupta, Noida (IN); Dhanyamraju S U M Prasad, Hyderabad (IN)

(21) Appl. No.: 19/037,135

(22) Filed: Jan. 25, 2025

(30) Foreign Application Priority Data
Feb. 20, 2024 (IN) 202411011901

(51) Int. Cl. G06F 16/3329; G06F 16/383

(52) U.S. Cl. CPC G06F 16/3329; G06F 16/383

(57) ABSTRACT

The disclosure relates to a method and system of generating training data for fine-tuning of a Machine Learning (ML) model. The method includes generating one or more natural language interpretations of a dataset corresponding to one or more parameters associated with configuration of the dataset, and collating the one or more natural language interpretations of the dataset corresponding to one or more parameters, to generate a combined natural language interpretation of the dataset. The method further includes generating a conceptual explanation of the dataset, based on the combined natural language interpretation of the dataset, and assigning one or more labels to each sub-dataset of the dataset, based on the conceptual explanation of the dataset, to generate training data for fine-tuning of the ML model, wherein the dataset comprises a plurality of sub-datasets.

### TECHNICAL FIELD

This disclosure relates generally to generating training data for Machine Learning (ML) models, and in particular to a method and a system for generating training data for fine-tuning of the ML models.

### BACKGROUND

Fine-tuning of Large Language Models (LLM) refers to a process of taking a pre-trained language model and further training it for a specific task or domain to improve its performance on that particular task. The pre-trained model, often a large-scale language model (for example, GPT-3), may be already trained on general language patterns and semantics from a vast amount of diverse data. Fine-tuning of the LLMs is a versatile approach that finds application in use cases including code generation, text summarization, question and answer generation, etc. Fine-tuning is also capable of overcoming industry challenges like data privacy, talent and knowledge retention, and continuous learning. Fine-tuning, as opposed to traditional training, does not start from scratch, but builds upon weights of a pre-trained model for a new requirement or a particular scenario. It uses data that is generally not available in open source or during the initial training, but is mostly domain-specific and custom data on which the model can be trained for a specific need. As such, the key distinction between training and fine-tuning is that while training starts from scratch with a randomly initialized model dedicated to a particular task and dataset, fine-tuning adds to a pre-trained model and modifies its weights to achieve better performance.

However, for fine tuning of LLM models for code, various challenges exist including preparing the code to fine-tune the model in an unsupervised way, and training the LLM model with a large corpus of domain-specific code that spans across various files and functions without taking the time and effort to understand the code. Further challenges include ensuring that the generated code after fine-tuning follows the existing design patterns and coding styles. Furthermore, there exist challenges as to taking care of the dependencies that are already in the code, and ensuring that the newly generated code follows the existing architecture.

Therefore, there is a need for solutions that overcome the above challenges, and provide effective and efficient ways of preparing code for fine-tuning the LLM model.

### SUMMARY

In an embodiment, a method of generating training data for fine-tuning of a Machine Learning (ML) model. The method may include generating one or more natural language interpretations of a dataset corresponding to one or more parameters associated with configuration of the dataset, and collating the one or more natural language interpretations of the dataset corresponding to one or more parameters, to generate a combined natural language interpretation of the dataset. The method may further include generating a conceptual explanation of the dataset, based on the combined natural language interpretation of the dataset, and assigning one or more labels to each sub-dataset of the dataset, based on the conceptual explanation of the dataset, to generate training data for fine-tuning of the ML model, wherein the dataset comprises a plurality of sub-datasets.

In another embodiment, a system for generating training data for fine-tuning of a Machine Learning (ML) model is disclosed. The system includes a processor and a memory communicatively coupled to the processor. The memory storing a plurality of processor-executable instructions, which upon execution by the processor, cause the processor to generate one or more natural language interpretations of a dataset corresponding to one or more parameters associated with configuration of the dataset, and collate the one or more natural language interpretations of the dataset corresponding to one or more parameters, to generate a combined natural language interpretation of the dataset. The plurality of processor-executable instructions, upon execution by the processor, further cause the processor to generate a conceptual explanation of the dataset, based on the combined natural language interpretation of the dataset, and assign one or more labels to each sub-dataset of the dataset, based on the conceptual explanation of the dataset, to generate training data for fine-tuning of the ML model, wherein the dataset comprises a plurality of sub-datasets.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 is a block diagram of an exemplary system for generating training data for fine-tuning of a Machine Learning (ML) model, in accordance with some embodiments of the present disclosure.

FIG. 2 is a functional block diagram of a fine-tuning device showing one or more modules, in accordance with some embodiments.

FIG. 3 is a process flow diagram of a process of generating training data for fine-tuning of a ML model, in accordance with some embodiments.

FIG. 4 is a flowchart of a method of generating training data for fine-tuning of a ML model, in accordance with some embodiments.

FIG. 5 is an exemplary computing system that may be employed to implement processing functionality for various embodiments.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims. Additional illustrative embodiments are listed below.

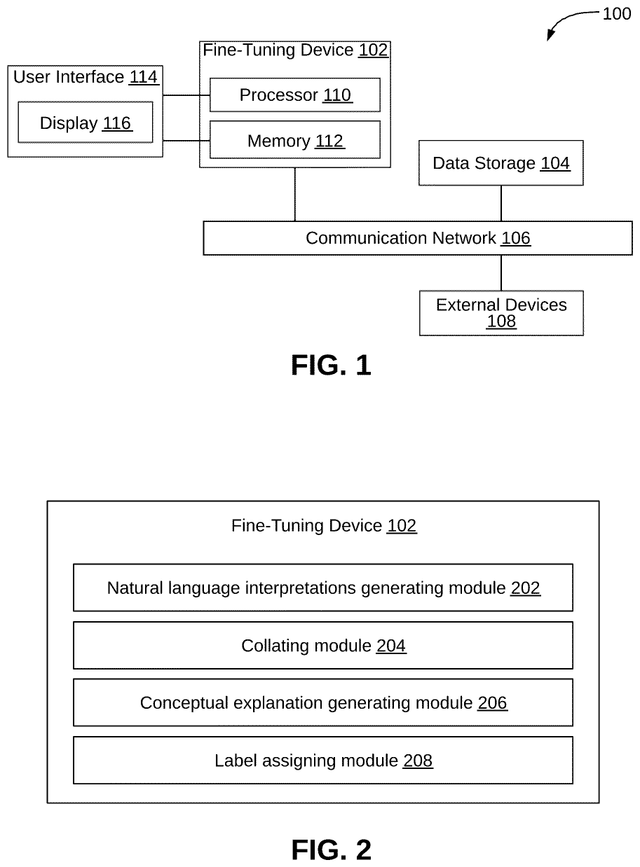

Referring now to FIG. 1, a block diagram of an exemplary system 100 for generating training data for fine-tuning of a Machine Learning (ML) model is illustrated, in accordance with some embodiments of the present disclosure. The system 100 may implement a fine-tuning device 102. Further, the system 100 may include a data storage 104. In some embodiments, the data storage 104 may store at least some of the data related to the workload. The fine-tuning device 102 may be a computing device having data processing capability. In particular, the fine-tuning device 102 may have the capability for generating training data for fine-tuning of a ML. Examples of the fine-tuning device 102 may include, but are not limited to a desktop, a laptop, a notebook, a netbook, a tablet, a smartphone, a mobile phone, an application server, a web server, or the like.

Additionally, the fine-tuning device 102 may be communicatively coupled to an external device 108 for sending and receiving various data. Examples of the external device 108 may include, but are not limited to, a remote server, digital devices, and a computer system. The fine-tuning device 102 may connect to the external device 108 over a communication network 106. The fine-tuning device 102 may connect to external device 108 via a wired connection, for example via Universal Serial Bus (USB). A computing device, a smartphone, a mobile device, a laptop, a smartwatch, a personal digital assistant (PDA), an e-reader, and a tablet are all examples of external devices 108. For example, the communication network 120 may be a wireless network, a wired network, a cellular network, a Code Division Multiple Access (CDMA) network, a Global System for Mobile Communication (GSM) network, a Long-Term Evolution (LTE) network, a Universal Mobile Telecommunications System (UMTS) network, a Worldwide Interoperability for Microwave Access (WiMAX) network, a Dedicated Short-Range Communications (DSRC) network, a local area network, a wide area network, the Internet, satellite or any other appropriate network required for communication between the fine-tuning device 102 and the data storage 104 and the external device 108.

The fine-tuning device 102 may be configured to perform one or more functionalities that may include generating one or more natural language interpretations of a dataset corresponding to one or more parameters associated with the configuration of the dataset. Each of the one or more natural language interpretations may be text-based. The one or more functionalities may further include collating the one or more natural language interpretations of the dataset corresponding to one or more parameters, to generate a combined natural language interpretation of the dataset. The combined natural language interpretation may be text-based. The one or more functionalities may further include generating a conceptual explanation of the dataset, based on the combined natural language interpretation of the dataset, and assigning one or more labels to the dataset, based on the conceptual explanation of the dataset.

To perform the above functionalities, the fine-tuning device 102 may include a processor 110 and a memory 112. The memory 112 may be communicatively coupled to the processor 110. The memory 112 stores a plurality of instructions, which upon execution by the processor 110, cause the processor 110 to perform the above functionalities. The system 100 may further include a user interface 114 which may further implement a display 116. Examples may include, but are not limited to a display, keypad, microphone, audio speakers, vibrating motor, LED lights, etc. The user interface 114 may receive input from a user and also display an output of the computation performed by the fine-tuning device 102.

Referring now to FIG. 2, a block diagram of the fine-tuning device 102 showing one or more modules is illustrated, in accordance with some embodiments. In some embodiments, the fine-tuning device 102 may include a natural language interpretations generating module 202, a collating module 204, a conceptual explanation generating module 206, and a label assigning module 208.

The fine-tuning device 102 may be configured to generate one or more natural language interpretations of a dataset corresponding to one or more parameters associated with the configuration of the dataset. It should be noted that each of the one or more natural language interpretations may be text-based.

In some embodiments, the one or more parameters associated with the configuration of the dataset may include a structure associated with the dataset, one or more dependencies associated with the dataset, an architecture associated with the dataset, and a format associated with the dataset. Further, in some embodiments, the structure associated with the dataset may include at least one of functions, methods, and classes associated with the dataset; one or more files within the dataset; one or more directories within the dataset; and a core task associated with the dataset. In some embodiments, the one or more dependencies associated with the dataset may include one or more variable dependencies, functional dependencies, and module dependencies. In some embodiments, the architecture associated with the dataset may include an algorithmic or design pattern, data structures, exceptions, and Input and Output values. In some embodiments, the format associated with the dataset may include at least one of: a style, an indentation, and comments associated with the dataset.

The collating module 204 may be configured to collating the one or more natural language interpretations of the dataset corresponding to one or more parameters, to generate a combined natural language interpretation of the dataset. The combined natural language interpretation may also be text-based. The conceptual explanation generating module 206 may generate a conceptual explanation of the dataset, based on the combined natural language interpretation of the dataset.

The label assigning module 208 may assign one or more labels to the dataset, based on the conceptual explanation of the dataset. In some embodiments, the label assigning module 208 may be further configured to identify a domain information, a context information, and metadata associated with the dataset, based on the conceptual explanation of the dataset. Further, the label assigning module 208 may assign the labels to the dataset, based on the domain information, the context information, and the metadata associated with the dataset.

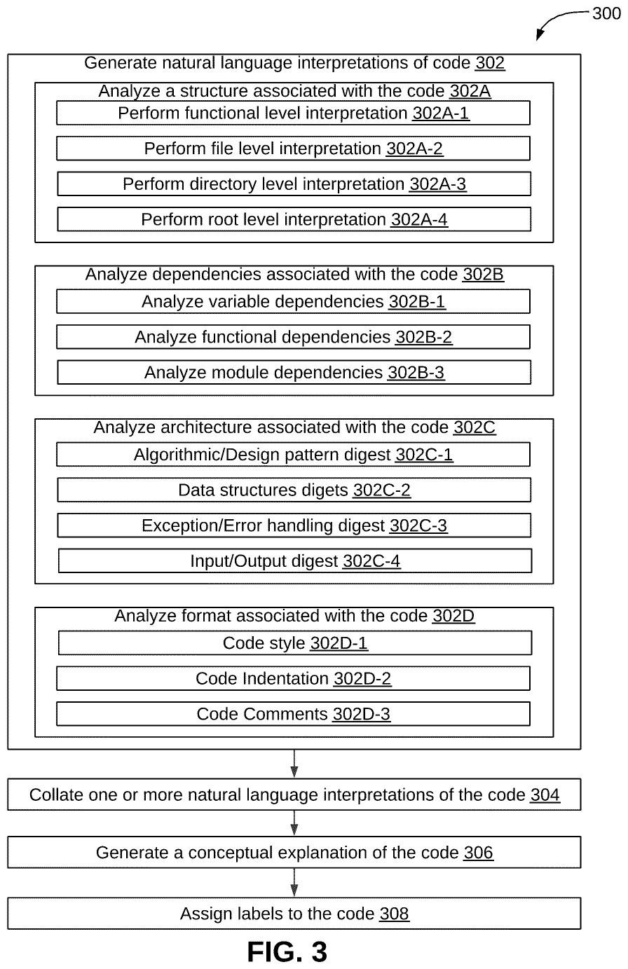

Referring now to FIG. 3, a process flow diagram of an overall process 300 of generating training data for fine-tuning of a ML model is illustrated, in accordance with some embodiments. As shown in FIG. 3 the overall process 300 may include various steps through step 302 to step 308.

At step 302, the one or more natural language interpretations of code (also referred to as “dataset” in this disclosure) may be generated, corresponding to one or more parameters associated with the configuration of the code. For example, the step 302 may be performed by the natural language interpretations generating module 202. The natural language interpretation may include an explanation of the code or functionality (which may be like a translation of the code to English or any natural language). As such, at step 302, the code may be analyzed from various aspects, such as code structure, dependencies, architecture, and formatting associated with the code. Based on the analysis, the natural language interpretation of the code may be generated. The step 302 may further include sub-steps 302A-302D.

At step 302A, the structure associated with the code may be analyzed. As mentioned above, the structure associated with the code may include at least one of: functions, methods, and classes associated with the code. The structure associated with the code may further include one or more files within the code. The structure associated with the code may further include one or more directories within the code. The structure associated with the code may further include a core task associated with the code.

At sub-step 302A, the structure associated with the code may be analyzed. In particular, at 302A-1 of the sub-step 302A, structure elements of the code may be analyzed. For example, the structure elements of the code may include at least one of: functions, methods, and classes associated with the code. As such, at 302A-1, the functions, methods and classes (if any) of the code may be analyzed. Accordingly, a first associated interpreted output may be generated, based on the examining the structure elements, i.e. The functions, the methods and the classes associated with the code. At 302A-2 of the sub-step 302A, one or more files within the code may be analyzed. Further, an overall objective of each file vis-a-vis the main program may be analyzed. Accordingly, a second associated interpreted output may be generated, based on the analysis of the one or more files within the code. At 302A-3 of the of the sub-step 302A, one or more directories or modules within the code may be analyzed. Further, at 302A-3, the organization of the one or more directories or modules within the code may be analyzed. Accordingly, a third associated interpreted output may be generated, based on the analysis of the one or more directories or modules within the code. At 302A-4 of the of the sub-step 302A, an overall program and the core task performed by the code may be analyzed. Accordingly, a fourth associated interpreted output may be generated, based on the analysis of the overall program and the core task associated with the code. It should be noted that a level of detail associated with each of the first, second, third, and fourth associated interpreted output may be different.

At sub-step 302B, the one or more dependencies associated with the code may be analyzed. The one or more dependencies may relate pre-requisites and other functionality needed to make the code work. As mentioned above, the one or more dependencies associated with the code may include variable dependencies, functional dependencies, and module dependencies. As such, at 302B-1 of the sub-step 302B, one or more variable dependencies associated with the code may be analyzed. The variable dependencies may be related to inter-dependencies and relational dependencies of variables, and their relationship with each other. Accordingly, a fifth associated interpreted output may be generated, based on the analysis of the one or more variable dependencies associated with the code. At 302B-2 of the sub-step 302B, one or more functional dependencies associated with the code may be analyzed. The functional dependencies may relate to process of calling the functions and methods, and a succession of using the functions and methods within a program. Accordingly, a sixth associated interpreted output may be generated, based on the analysis of the one or more functional dependencies associated with the code. At 302B-3 of the sub-step 302B, the one or more module dependencies may be analyzed. The module dependencies may relate to inter-dependence of one or more modules within the program, and the sequence of calling of the one or more modules during the program flow. Accordingly, a seventh associated interpreted output may be generated, based on the analysis of the one or more module dependencies associated with the code.

At sub-step 302C, an architecture associated with the code may be analyzed. The architecture may provide design pattern or the code architecture that is being followed. As mentioned above, the architecture associated with the code may include an algorithmic or design pattern, data structures, exceptions, and Input and Output values. In particular, at 302C-1 of the sub-step 302C, an algorithmic or design pattern associated with the code may be analyzed. Accordingly, an eight associated interpreted output may be generated, based on the analysis of the algorithmic or design pattern associated with the code. At 302C-2 of the sub-step 302C, data structures associated with the code may be analyzed. Accordingly, a ninth associated interpreted output may be generated, based on the analysis of the data structures associated with the code. At 302C-3 of the sub-step 302C, exceptions (or error handlings) associated with the code may be analyzed. Accordingly, a tenth associated interpreted output may be generated, based on the analysis of the exceptions (or error handlings) associated with the code. At 302C-4 of the sub-step 302C, Input and Output values associated with the code may be analyzed. Accordingly, an eleventh associated interpreted output may be generated, based on the analysis of the Input and Output values associated with the code.

At sub-step 302D, a formatting associated with the code may be analyzed. As will be understood, the format may relate to how the functions are written, the spacing, style, etc., and how the variables are given. As mentioned above, the formatting associated with the code may include at least one of: a style, an indentation, and comments associated with the code. The formatting (precis) may relate to aspects as to how the code is written. In particular, at 302D-1 of the sub-step 302D, the style associated with the code may be analyzed. Accordingly, a twelfth associated interpreted output may be generated, based on the analysis of the style associated with the code. At 302D-2 of the sub-step 302D, the indentation associated with the code may be analyzed. Accordingly, a thirteenth associated interpreted output may be generated, based on the analysis of the indentation associated with the code. At 302D-3 of the sub-step 302D, the comments associated with the code may be analyzed. Accordingly, a fourteenth associated interpreted output may be generated, based on the analysis of the comments associated with the code.

At step 304, the collating the one or more natural language interpretations of the code corresponding to one or more parameters may be collated, to generate a combined natural language interpretation of the code. For example, the step 304 may be performed by the collating module 204. In particular, a set of interpreted outputs (i.e. including the first, second, third, fourth, fifth, sixth, seventh, eighth, ninth, tenth, eleventh, twelfth, thirteenth, and fourteenth associated interpreted outputs) generated above may be collated to generate the combined natural language interpretation of the code.

At step 306, a conceptual explanation of the code may be generated, based on the combined natural language interpretation of the code. The conceptual explanation may provide a gist of the functionality focusing on understanding the functionality holistically. For example, the step 306 may be performed by the conceptual explanation generating module 206. In particular, at step 306, the conceptual explanation generating module 206 may generate the conceptual explanation of the code (based on the combined natural language interpretation of the code) in human understandable form with necessary details and levels of abstraction.

In some embodiments, generating the conceptual explanation of the code may include a first approach and a second approach. The first approach may include generation of abstract and brief interpretations based on the set of interpreted outputs. The second approach may include generation of para-phrased interpretations of the based on the set of interpreted outputs. The first approach and the second approach may be performed recursively on each interpreted output of the set of interpreted outputs (from step 302), to generate the conceptual explanation in human understandable form. The conceptual explanation may describe the program (i.e. code) in a comprehensive manner using the set of interpreted outputs from the step 302. In some embodiments, at step 306, the information is may be segregated into a high-level design and a low-level design that may provide information about the architecture, directory structure, organization of the code, function level details, and dependencies associated with the code. The low-level design may give granular details (for example, in Example 2 (below), the low-level design may give Function and Exceptions; in Example 3 (below), and the low-level design may give usage details. The high-level design may describe the top level functions generally at a module level. The high-level design may be mostly applicable to modules and to the project as a whole.

At step 308, one or more labels may be assigned to the code, based on the conceptual explanation of the dataset. For example, the step 308 may be performed by the label assigning module 208.

In some embodiments, at step 308, the conceptual explanation of the code (generated at step 306) may be combined with domain information, context information, and metadata tagging to generate training data for fine-tuning the ML model. The domain information may relate to a specific scenario or project for which the fine tuning is required. The domain information may enable the ML model to learn the specific domain information which is to be used when generating the code for a specific problem. The context information may provide information pertaining to the code with additional details. The context information may enable the ML model to learn the aspects of the code on which it is getting trained. The metadata may be any data associated with the code providing information, like the comments.

For example, when the context information indicates that the data is related to the functions in the code, then the context information may enable the ML model to generate function signatures of similar nature. Similarly, when design pattern information is given as the context information, the generated code may follow the supported design patterns. By way of metadata tagging, tags (labels) maybe assigned to each chunk of code (i.e. subset of the dataset), to provide a reference to the code. The labels may assist in the correlation of the code during the fine-tuning. Upon labeling, training data is generated which can be used for fine-tuning the ML model.

### Example 1

A first example code (dataset) is given below:

```
def read_file_from_server(ip, username, password, pem_file, remote_file_name,
localfilepath):
  host = ip
  # Instantiate a client
  client = paramiko.SSHClient( )
  client.set_missing_host_key_policy(paramiko.AutoAddPolicy( ))
  # connect with the given permission file
  if (pem_file != ″):
    client.connect(host, username=username, key_filename=pem_file)
  else:
  # use default settings for connecting
    client.connect(host, username=username, password=password)
  sftp = client.open_sftp( )
  sftp.get(remote_file_name, localfilepath)
  sftp.close( )
  client.close( )
```

For the above example dataset, the natural language interpretation generated may be as follows:
1. It takes the IP address of the remote sever, the username for logging, the password for the same, the name of the remote file and the location where the file to be downloaded to, as input arguments.
2. The function connects to the remote server using the username and password or ssh key file and then using SFTP protocol it gets the file from the specified folder
3. It closes the SFTP session and the ssh connection.

Further, for the above example dataset, the conceptual explanation generated may be as follows:
This function is used to read a file from a remote server using SSH and saves it to a local file path. This follows a client server architecture.

For the above example dataset, the context information may be as follows:
SSH stands for Secure Shell
Paramiko is a python implementation of SSH
SFTP stands for Secure File Transfer Protocol

For the above example dataset, the dependencies may be as follows:
paramiko
scp module in the paramiko library

### Example 2

A second example code (dataset) is given below:

```
def LLM_predict(cloudconfig, instanceid, promptfile):
  with open(cloudconfig, ‘r’) as config_f:
    cloud_infra = json.load(config_f)
  config_f.close( )
  aws_access_key_id = cloud_infra[‘AWS_EC2’][‘AWSAccessKeyID’]
  aws_secret_key = cloud_infra[‘AWS_EC2’][‘AWSSecretAccessKey’]
  region = cloud_infra[‘AWS_EC2’][‘LLaMa7B’][‘RegionName’]
  ip = start_instance(aws_access_key_id, aws_secret_key, instanceid, region)
  currentDirectory = os.path.dirname(os.path.abspath(_file_))
  pem_file = os.path.join(currentDirectory,
cloud_infra[‘AWS_EC2’][‘LLaMa7B’][‘ssh’][‘keyFilePath’])
  username = cloud_infra[‘AWS_EC2’][‘LLaMa7B’][‘ssh’][‘userName’]
  copy_files_to_server(ip, pem_file, promptfile, ‘’, username)
  promptfile = os.path.basename(promptfile)
  command = ((((prompt_command + ‘ ’) + remote_data_dir) + ‘/’) + promptfile)
  buf = run_ssh_cmd(ip, pem_file, username, ‘’, command)
  return buf
```

For the above example dataset, the natural language interpretation generated may be as follows:
1. The function will take the instance ID and pem file path as arguments. It will start the instance. Then it will copy the user's file on to the instance and run the command on the command line on the started instance.
2. Dependency:
3. The function has dependency on AWS credentials to start the instance.
4. It has dependency to paramiko library to connect to the started instance via ssh.
5. It depends on boto3 to start the instance.

For the above example dataset, the classes may be as follows:
The function uses class boto3 to start instances in AWS.
It uses the class paramiko to connect to an EC2 via SSH.

For the above example dataset, the functions may be as follows:
It uses the function start_instances from class boto3
It uses function copy_files_to_server from paramiko
It uses function run_ssh_cmd of paramiko

For the above example dataset, the exceptions may be as follows:
boto3.exceptions (ClientError)
paramiko.SSHException
Paramiko.SFTPError

### Example 3

A third example code (dataset) is given below:
def aion_aws_training(confFile):
   from hyperscalers.aion_aws_training import awsTraining
   status=awsTraining(confFile)
   print(status)

For the above example dataset, the natural language interpretation generated may be as follows:
1. AION training script runs aion-aws training on a given configuration file.

For the above example dataset, the dependencies may be as follows:
The script requires the following libraries to be installed. os, sys, logging, yaml_config, aion_aws_training, aion_train.

For the above example dataset, the usage may be as follows:
To run this module, execute the following command:
>python aion_aws_training.py-a <configuration file for aws training>

For the above example dataset, the configuration may be as follows:
This module takes one configuration file and uses all the default values.

In the above example, AION is the domain information since this code is pertaining to the domain AION.

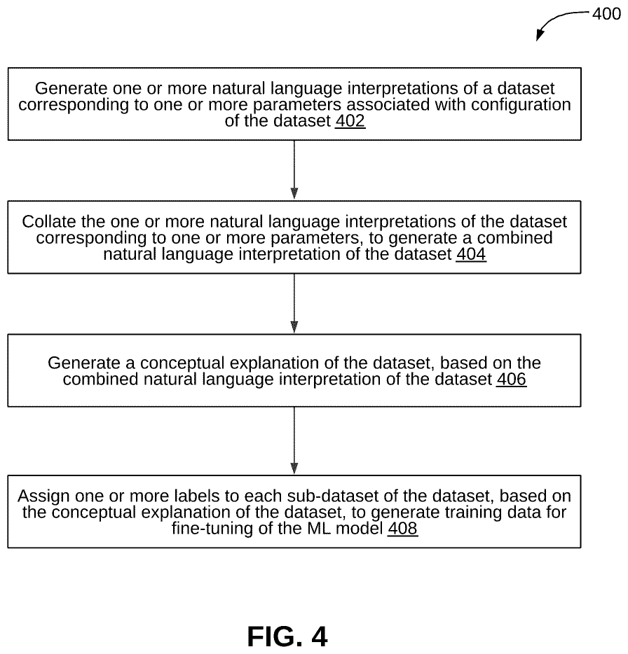

Referring now to FIG. 4, a flowchart of a method 400 of generating training data for fine-tuning of a ML is illustrated, in accordance with some embodiments. For example, the method 400 may be performed by the fine-tuning device 102.

At step 402, one or more natural language interpretations of a dataset may be generated, corresponding to one or more parameters associated with the configuration of the dataset. Each of the one or more natural language interpretations may be text-based. At step 404, the one or more natural language interpretations of the dataset corresponding to one or more parameters may be collated, to generate a combined natural language interpretation of the dataset, wherein the combined natural language interpretation is text-based.

In some embodiments, the one or more parameters associated with the configuration of the dataset may include a structure associated with the dataset, one or more dependencies associated with the dataset, an architecture associated with the dataset, and a format associated with the dataset. Further, in some embodiments, the structure associated with the dataset may include at least one of functions, methods, and classes associated with the dataset; one or more files within the dataset; one or more directories within the dataset; and a core task associated with the dataset. In some embodiments, the one or more dependencies associated with the dataset may include one or more variable dependencies, functional dependencies, and module dependencies. In some embodiments, the architecture associated with the dataset may include an algorithmic or design pattern, data structures, exceptions, and Input and Output values. In some embodiments, the format associated with the dataset may include at least one of: a style, an indentation, and comments associated with the dataset.

At step 406, a conceptual explanation of the dataset may be generated, based on the combined natural language interpretation of the dataset. In some embodiments, the conceptual explanation of the dataset may include at least one of a high-level design associated with the dataset, and a low-level design associated with the dataset.

At step 408, one or more labels may be assigned to each sub-dataset of the dataset, based on the conceptual explanation of the dataset, to generate training data for fine-tuning of the ML model. The dataset may include a plurality of sub-datasets. In some embodiments, in order to assign one or more labels, at step 408, additionally, a domain information, a context information, and metadata associated with the dataset may be identified, based on the conceptual explanation of the dataset. As such, further, at step 408, the one or more labels may be assigned to the dataset, based on the domain information, the context information, and the metadata associated with the dataset.

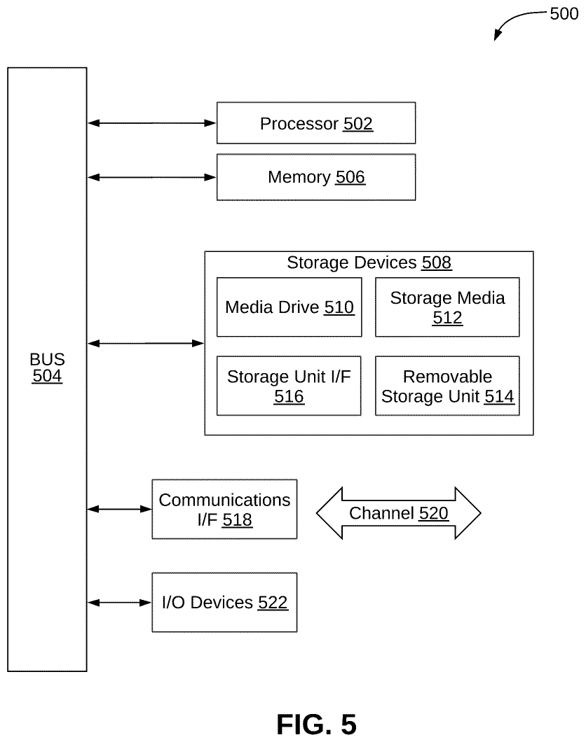

Referring now to FIG. 5, an exemplary computing system 500 that may be employed to implement processing functionality for various embodiments (e.g., as a SIMD device, client device, server device, one or more processors, or the like) is illustrated. Those skilled in the relevant art will also recognize how to implement the invention using other computer systems or architectures. The computing system 500 may represent, for example, a user device such as a desktop, a laptop, a mobile phone, personal entertainment device, DVR, and so on, or any other type of special or general-purpose computing device as may be desirable or appropriate for a given application or environment. The computing system 500 may include one or more processors, such as a processor 502 that may be implemented using a general or special purpose processing engine such as, for example, a microprocessor, microcontroller or other control logic. In this example, the processor 502 is connected to a bus 504 or other communication media. In some embodiments, the processor 502 may be an Artificial Intelligence (AI) processor, which may be implemented as a Tensor Processing Unit (TPU), or a graphical processor unit, or a custom programmable solution Field-Programmable Gate Array (FPGA).

The computing system 500 may also include a memory 506 (main memory), for example, Random Access Memory (RAM) or other dynamic memory, for storing information and instructions to be executed by the processor 502. The memory 506 also may be used for storing temporary variables or other intermediate information during the execution of instructions to be executed by processor 502. The computing system 500 may likewise include a read-only memory (“ROM”) or other static storage device coupled to bus 504 for storing static information and instructions for the processor 502.

The computing system 500 may also include storage devices 508, which may include, for example, a media drive 510 and a removable storage interface. The media drive 510 may include a drive or other mechanism to support fixed or removable storage media, such as a hard disk drive, a floppy disk drive, a magnetic tape drive, an SD card port, a USB port, a micro-USB, an optical disk drive, a CD or DVD drive (R or RW), or other removable or fixed media drive. A storage media 512 may include, for example, a hard disk, magnetic tape, flash drive, or other fixed or removable media that is read by and written to by the media drive 510. As these examples illustrate, the storage media 512 may include a computer-readable storage medium having stored therein particular computer software or data.

In alternative embodiments, the storage devices 508 may include other similar instrumentalities for allowing computer programs or other instructions or data to be loaded into the computing system 500. Such instrumentalities may include, for example, a removable storage unit 514 and a storage unit interface 516, such as a program cartridge and cartridge interface, a removable memory (for example, a flash memory or other removable memory module) and memory slot, and other removable storage units and interfaces that allow software and data to be transferred from the removable storage unit 514 to the computing system 500.

The computing system 500 may also include a communications interface 518. The communications interface 518 may be used to allow software and data to be transferred between the computing system 500 and external devices. Examples of the communications interface 518 may include a network interface (such as an Ethernet or other NIC card), a communications port (such as for example, a USB port, a micro-USB port), Near field Communication (NFC), etc. Software and data transferred via the communications interface 518 are in the form of signals which may be electronic, electromagnetic, optical, or other signals capable of being received by the communications interface 518. These signals are provided to the communications interface 518 via a channel 520. The channel 520 may carry signals and may be implemented using a wireless medium, wire or cable, fiber optics, or other communications medium. Some examples of the channel 520 may include a phone line, a cellular phone link, an RF link, a Bluetooth link, a network interface, a local or wide area network, and other communications channels.

The computing system 500 may further include Input/Output (I/O) devices 522. Examples may include, but are not limited to a display, keypad, microphone, audio speakers, vibrating motor, LED lights, etc. The I/O devices 522 may receive input from a user and also display an output of the computation performed by the processor 502. In this document, the terms “computer program product” and “computer-readable medium” may be used generally to refer to media such as, for example, the memory 506, the storage devices 508, the removable storage unit 514, or signal(s) on the channel 520. These and other forms of computer-readable media may be involved in providing one or more sequences of one or more instructions to the processor 502 for execution. Such instructions, generally referred to as “computer program code” (which may be grouped in the form of computer programs or other groupings), when executed, enable the computing system 500 to perform features or functions of embodiments of the present invention.

In an embodiment where the elements are implemented using software, the software may be stored in a computer-readable medium and loaded into the computing system 500 using, for example, the removable storage unit 514, the media drive 510 or the communications interface 518. The control logic (in this example, software instructions or computer program code), when executed by the processor 502, causes the processor 502 to perform the functions of the invention as described herein.

One or more techniques for selecting deployment model and deployment type for a workload are disclosed. The techniques ensure that all aspects of the code are distilled into the training data and no aspect is lost. Further, the techniques do away with the need of manual intervention to generate the training data, and therefore, the process of generating the training data is automated.

It is intended that the disclosure and examples be considered as exemplary only, with a true scope and spirit of disclosed embodiments being indicated by the following claims.

What is claimed is:

1. A method of generating training data for fine-tuning of a Machine Learning (ML) model, the method comprising:
generating one or more natural language interpretations of a dataset corresponding to one or more parameters associated with configuration of the dataset, wherein each of the one or more natural language interpretations is text-based;
collating the one or more natural language interpretations of the dataset corresponding to one or more parameters, to generate a combined natural language interpretation of the dataset, wherein the combined natural language interpretation is text-based;
generating a conceptual explanation of the dataset, based on the combined natural language interpretation of the dataset; and
assigning one or more labels to each sub-dataset of the dataset, based on the conceptual explanation of the dataset, to generate training data for fine-tuning of the ML model, wherein the dataset comprises a plurality of sub-datasets.

2. The method of claim 1, further comprising:
identifying a domain information, a context information, and metadata associated with the dataset, based on the conceptual explanation of the dataset; and
assigning one or more labels to the dataset, based on the domain information, the context information, and the metadata associated with the dataset.

3. The method of claim 1, wherein the one or more parameters associated with the configuration of the dataset comprise: a structure associated with the dataset, one or more dependencies associated with the dataset, an architecture associated with the dataset, and a formatting associated with the dataset.

4. The method of claim 3, wherein the structure associated with the dataset comprises:
at least one of: functions, methods, and classes associated with the dataset;
one or more files within the dataset;
one or more directories within the dataset; and
a core task associated with the dataset.

5. The method of claim 3, wherein the one or more dependencies associated with the dataset comprise: one or more variable dependencies, functional dependencies, and module dependencies.

6. The method of claim 3, wherein the architecture associated with the dataset comprises: an algorithmic or design pattern, data structures, exceptions, and Input and Output values.

7. The method of claim 3, wherein the formatting associated with the dataset comprises at least one of: a style, an indentation, and comments associated with the dataset.

8. The method of claim 1, wherein the conceptual explanation of the dataset comprises at least one of:
a high-level design associated with the dataset; and
a low-level design associated with the dataset.

9. A system for generating training data for fine-tuning of a Machine Learning (ML) model, the system comprising:
a processor;
a memory communicatively coupled to the processor, the memory storing a plurality of processor-executable instructions, wherein the processor-executable instructions, upon execution by the processor, cause the processor to:
generate one or more natural language interpretations of a dataset corresponding to one or more parameters associated with configuration of the dataset, wherein each of the one or more natural language interpretations is text-based;
collate the one or more natural language interpretations of the dataset corresponding to one or more parameters, to generate a combined natural language interpretation of the dataset, wherein the combined natural language interpretation is text-based;
generate a conceptual explanation of the dataset, based on the combined natural language interpretation of the dataset; and
assign one or more labels to each sub-dataset of the dataset, based on the conceptual explanation of the dataset, to generate training data for fine-tuning of the ML model, wherein the dataset comprises a plurality of sub-datasets.

10. The system of claim 9, wherein processor-executable instructions, upon execution by the processor, cause the processor to:
identify a domain information, a context information, and metadata associated with the dataset, based on the conceptual explanation of the dataset; and
assign one or more labels to the dataset, based on the domain information, the context information, and the metadata associated with the dataset.
